(19) United States
(12) Patent Application Publication
(10) Pub. No.: US 2014/0087171 A1
(43) Pub. Date: Mar. 27, 2014

(54) Carbon Fiber Reinforced Eutectic Alloy Materials and Methods of Manufacture

(71) Applicant: Vanguard Space Technologies, Inc., San Diego, CA (US)

(72) Inventors: Eldon P. KASL, Poway, CA (US); Matthew W. Thompson, San Diego, CA (US)

(73) Assignee: Vanguard Space Technologies, Inc., San Diego, CA (US)

(21) Appl. No.: 14/032,045

(22) Filed: Sep. 19, 2013

Related U.S. Application Data
(60) Provisional application No. 61/704,279, filed on Sep. 21, 2012.

(51) Int. Cl. C22C 49/14; B23K 31/02

(52) U.S. Cl. CPC C22C 49/14; B23K 31/02
USPC 428/222; 427/299; 228/203; 428/221

(57) ABSTRACT

Certain embodiments here include compositions of matter and methods of manufacturing a ply composition, comprising a piece of fabric, wherein the fabric includes a plurality of plated tows, and eutectic alloy, wherein the plated tows are intertwined with the eutectic alloy.

### STATEMENT OF RELATED CASES

This patent application claims priority from and is related to U.S. Provisional application 61/704,279 filed 21 Sep. 2012, which is hereby incorporated by reference in its entirety.

### TECHNICAL FIELD

The present invention relates to a carbon fiber reinforced eutectic alloy material and methods of manufacture.

### BACKGROUND OF THE INVENTION

Space-based instrument applications often use carbon fiber reinforced polymer composite materials to obtain high specific stiffness and near zero coefficient of thermal expansion properties in space qualified structures. Current space qualified carbon fiber reinforced laminate resins are hygroscopic and consist of epoxy, cyanate ester, bismaleimide, or siloxane resins. During optical system design, integration, and operation, the effects of polymer composite laminate in-plane and out-of-plane moisture strain must be considered, understood, and predicted or measured to ensure acceptable on-orbit optical alignment.

Existing carbon fiber reinforced polymer laminates respond to changes in laminate moisture content (% by weight) through elongation, swelling, and/or shrinkage (strain). Moisture content change is a function of the available diffusive surface area, laminate thickness, difference between ambient and in situ humidity, difference between environmental and structure temperature, and duration over which such changes occur.

### SUMMARY

In accordance with the currently referenced technologies of this engineered material application, materials constructed of carbon fibers reinforced with eutectic metal alloys are combined in novel ways.

Certain example embodiments may include a ply composition, comprising a piece of fabric, wherein the fabric includes a plurality of plated tows, and eutectic alloy, wherein the plated tows are intertwined with the eutectic alloy. Examples may include where wherein the fabric integrated with a eutectic alloy is shaped as at least one of, a tube, a sheet and a ribbon. Examples may include wherein the tows are comprised of a plurality of carbon filaments.

Examples here may include embodiments wherein the eutectic alloy is at least one of, Indium Alloy #1e including indium and tin, Indium Alloy #205 including indium and lead, Indium Alloy #256 including tin, silver, and copper, Indium Alloy #28 including bismuth and tin, Indium Alloy #282 including bismuth and tin, Indium Alloy #11 including lead, tin and silver, and Indium Alloy #12, including lead, tin and silver. Certain examples may include wherein the plating is at least one of, copper and nickel, and wherein the fabric includes at least one of, woven tows, unidirectional tows and chopped fiber tows. Some examples include the plurality of carbon filaments between 5 to 8 microns in diameter, and some where the tow is between 2 to 2.5 millimeters in diameter.

Some example embodiment include a method of manufacturing a laminate material, including removing tow sizing on a piece of woven carbon fiber tows, plating the woven carbon fiber tows, placing a piece of eutectic alloy on the plated piece of woven carbon fiber tows, applying at least one of pressure and/or heat to the piece of eutectic alloy and plated piece of woven carbon fiber tows, thereby melting the eutectic alloy to create a ply. Some examples may include the method further comprising, stacking at least two plies, applying pressure and heat to the at least two plies, thereby fusing the at least two plies. Some examples include a method wherein the applying heat includes a temperature ramp of 15-20° C. per minute. And some wherein the carbon fiber tows include a plurality of carbon filaments.

Certain examples include methods where the plating is at least one of, copper and nickel. Certain examples include the method wherein the eutectic alloy is at least one of, Indium Alloy #1e including indium and tin, Indium Alloy #205 including indium and lead, Indium Alloy #256 including tin, silver, and copper, Indium Alloy #28 including bismuth and tin, Indium Alloy #282 including bismuth and tin, Indium Alloy #11 including lead, tin and silver, and Indium Alloy #12, including lead, tin and silver. And some embodiment include methods wherein the sizing is a lubricant and bonding agent, and some where the tows are comprised of a plurality of carbon filaments between 5 to 8 microns in diameter. Certain examples include methods where the tow is between 2 to 2.5 millimeters in diameter, and some where the applying pressure includes 10-15 psig.

Some example embodiments may include a eutectic alloy embedded with a carbon fiber prepared by a process comprising, selecting a fiber tow material, selecting a type for the fiber tow material, selecting a form for the fiber tow material, removing a sizing from the fiber tow material, establishing a target fiber areal weight for the fiber tow material, selecting a eutectic material, selecting a shape type for the eutectic material, selecting a material thickness for the eutectic material, selecting a tow plating material, selecting a thickness for the tow plating material, aligning and securing the tow material on a support plate, placing the eutectic material on the fiber tow material, and applying at least one of, pressure and heat, to the eutectic material and fiber tow material, thereby melting the eutectic material and forcing the eutectic material into spaces around the fiber tow material to form a ply. Some example embodiments may include where the eutectic alloy is embedded with a carbon fiber prepared by a process further comprising, stacking at least two plies on at least one of a lay-up table and a mold, securing a bagging material to the plies, applying a vacuum to the bagged plies, applying at least one of pressure and heat to the bagged plies, thereby fusing the at least two plies.

Some embodiments may include a lay-up method of manufacturing a material, including, cutting dry carbon fiber fabric to a dimension, taping the perimeter of the cut dry carbon fiber fabric dimension to provide edge dams to contain a eutectic alloy during reflow, placing the cut dry carbon fabric on a release ply, cutting a eutectic alloy preform to match the dimensions of at least one of, the cut dry carbon fiber fabric and the dam, laying the eutectic alloy preform on top of the dry carbon fabric to form a stack, pre-heating a platen press, loading the stack into the platens, applying pressure with the platens to the stack, holding the pressure on the stack for a hold time, opening the platens, removing the stack, and cooling the stack. Some example methods may include where the release ply is an Armalon cloth. Some examples may have the method further comprising, after laying the eutectic alloy preform on top of the dry fabric preform, placing a second layer of release ply on top of the stack. And some example methods include where the release ply is an Armalon cloth.

Example embodiments here may include methods where pre-heating the platen press is to a temperature of +10° C. over a liquidus temperature of the eutectic alloy. And some examples may include wherein pre-heating the platen press is to a temperature of +20° C. over a liquidus temperature of the eutectic alloy. Some example methods include wherein the applying pressure with the plates is between 500-1500 psi. And in some methods the hold time is between 10-25 minutes.

Some example embodiments include an autoclave method of manufacturing a material, comprising, selecting fiber tow material, selecting a fiber tow type, selecting a form of the fiber tow material, removing a tow sizing from the fiber tow material, establishing a target fiber areal weight of the fiber tow material, selecting eutectic material, selecting a eutectic material type, selecting a eutectic material thickness, selecting a tow plating material, selecting a tow plating material thickness, aligning and securing the tow material on a support plate, placing the eutectic material on the tow material, applying at least one of pressure and heat, thereby melting and forcing the eutectic material into the spaces around the tow material, creating a ply. Examples methods may also include stacking at least two plies on at least one of a lay-up table and a mold, securing a bag material to the stacked plies, applying a vacuum to the bagged stacked plies, applying at least one of pressure and heat, thereby fusing the stacked plies.

### BRIEF DESCRIPTION OF THE DRAWINGS

FIG. 1A illustrates an example longitudinal (top) view of material in accordance with certain embodiments herein.

FIG. 1B illustrates an example detail of a longitudinal view of material in accordance with certain embodiments herein.

FIG. 2A illustrates an example cross sectional (side) view of the material in accordance with certain embodiments herein.

FIG. 2B illustrates example cross sectional (side) views of the material in accordance with certain embodiments herein.

FIG. 3 is a block diagram illustrating an example manufacturing procedure for the material using a 2-D press method in accordance with certain embodiments herein.

FIG. 4 is a block diagram illustrating an example manufacturing procedure for using the material in a tube configuration in accordance with certain embodiments herein.

FIG. 5A is a block diagram illustrating an example alternative manufacturing procedure using an autoclave method in accordance with certain embodiments herein.

FIG. 5B is an example diagram illustrating a lay-up machine, in accordance with certain embodiments herein.

FIG. 6 is a block diagram illustrating an example manufacturing method to impregnate carbon fiber tow in accordance with certain embodiments herein.

FIG. 7 illustrates example extra-terrestrial telescopes in accordance with certain embodiments herein.

### DETAILED DESCRIPTION

In the following detailed descriptions, numerous specific details are set forth to illustrate the subject matter presented in this document. It will, however, be apparent to one of ordinary skill in the art that the subject matter may be practiced without these exact specific details. Moreover, the descriptions are provided by way of example and should not be used to limit the scope of any later claimed inventions.

### Overview

Certain example embodiments here include materials made of carbon fibers reinforced with eutectic metal alloys. The resultant materials may exhibit moisture insensitivity and may not exhibit laminate in-plane and out-of-plane strain resulting from moisture absorption and desorption. Further, various methods of manufacture may be used to create various embodiments of the materials disclosed herein.

Spacecraft instrumentation and structures may be subjected to various environmental conditions inherent in outer space, for instance when such a structure is placed in an orbit around the Earth. And factors such as view factor, and duty cycle of the spacecraft may call for specific material characteristics as well. Further, space-based instrumentation may require inherent structural stability to maintain alignment and meet operational performance requirements as the instrumentation may be oriented a particular way, or fit a certain way in a certain system in relation to other subsystems.

For example, material characteristics such as thermal conductivity, thermal capacitance, thermal diffusivity, and density, may influence steady-state and transient distortion within a sensor. To obtain desired performance in space, structures may require active or passive thermal design provisions. Such example thermal provisions may reduce thermally induced strain or changes in heat flow to reduce structure elongation, change in the laminate thickness, and distortions of materials, placed in space. Providing particular thermal interface materials may also help manage heat flow within the system, helping to avoid hot spots, and may reduce thermal gradients, thus resulting in reduced thermal strains.

Embodiments of the eutectic reinforced carbon fiber material described here may be used in many applications, including, for example, space deployed telescopes, satellites, space vehicles, and unmanned aerial vehicle sensors, to name a few. Such applications, in certain embodiments may provide both thermal continuity as well as stable material performance while the assembly is operating in the space borne environment.

For example, in telescopic example embodiments, certain embodiments of the material disclosed here may help eliminate optical system misalignment due to laminate moisture strain and thereby allow a simplification of optical system integration and focusing, thus possibly improving on-orbit operational reliability. Thus, with high thermal conductivity and low coefficient of thermal expansion, the eutectic alloy carbon fiber structure example embodiments may be much less susceptible to wavefront degradation as a result of thermal gradients stemming from uneven heat distribution in the example structure. These characteristics may all play a part in the example material's thermal conductivity and therefore, the material's thermal interface characteristics with mounted components.

Additionally, various fiber and eutectic alloy example embodiment combinations disclosed here may provide laminate moisture insensitivity with tailorable in-plane thermal and structural properties and particular thermal conductivity in the laminate through thickness direction. Additionally, example embodiments may also exhibit particular desirable characteristics, such as, in-plane and transverse shear strength, inter-laminar shear strength, compression strength, flatwise tension, and through thickness compression modulus. In terms of strain, eutectic alloys are insensitive to moisture absorption and in combination with various intermediate and high modulus fiber reinforcements, possess tailorable design properties.

Example shapes of the material may include flat and tubular laminate designs, for example, depending on the application. The material constituents can include, for example: plated, continuous, carbon fibers and also: eutectic alloy in flat ribbon form (preform).

### Space Deployed Examples

Materials used in engineering objects that orbit the Earth or are sent into space undergo particular environmental rigors. Among those rigors are vacuum exposure and temperature fluctuation. It is often desirable to use materials in a space deployment application that do not physically change state or form when exposed to these rigors, including moisture desorption due to vacuum. The example embodiments disclosed here may reduce or eliminate laminate in-plane and out-of-plane strain resulting from moisture absorption/desorption. Further, they may exhibit stable thermal conductivity when exposed to particular temperature fluctuations, such as those in space.

Moisture, found in on and around the material, may be a factor in ground/Earth testing and the possibility of including moisture into, on or around a material before it is sent up into the atmosphere or beyond. Though efforts are made to reduce moisture content of the assembly prior to launch, it may not be possible to remove all the moisture for hygroscopic materials. As the environment in low Earth orbit and deep space is essentially without any moisture content, certain moisture transport out of the material may result in distortions and potential strains of and/or on the material. Thus, for example, in an atmospheric and/or space deployed telescope application, reducing moisture and thermally induced strain by reducing moisture devolvement and improving thermal conductivity and material homogeneity minimizes, for example, pointing/focusing/alignment errors and permits reallocation of telescope error budget, simplifying integration and test activities, and reduction in mass budget for space borne structures. Many other various uses of such material exist, the telescope example being illustrative and not limiting.

It should be noted that throughout this disclosure, the terms “space,” “outer space,” “upper Earth atmosphere,” “orbit,” and other such terms are used. These terms are to be construed as referring to distances above the Earth, ranging from thousands of feet to many miles above the Earth. But in this document, the terms are generally used in regard to any altitude above the Earth, the upper Earth atmosphere and beyond into space, and are used interchangeably. They are not to be considered limiting in their usage, to one particular altitude, or region of Earth's atmosphere and/or space.

### Eutectic Examples

Example embodiments of materials here include eutectic alloys which may not absorb nor desorb moisture in use. The result may be a material that lacks the mechanism causing strains due to changes in moisture content and moisture content changes. Eutectic alloys, may also exhibit inherent thermal conductivity of the parent materials, and may provide conductive thermal interfaces while utilizing the intermediate or high modulus of the fiber reinforcement to resist thermal elongation and distortions. While the eutectic alloys exhibit varying thermally conductive properties based upon their alloying material constituent components, the constituent materials making up those alloys all exhibit thermal conductivity and thermal expansion and contraction characteristics when exposed to changes in temperature. The stabilizing effect that the low strain, intermediate to high modulus fiber reinforcement has on a final laminated product may enable the materials to provide thermal interface properties beneficial to aerospace applications requiring, for example, characteristics such as specific heat and thermal conductivity and also thermal stability under temperature changes and temperature gradients throughout the material.

The term “eutectic” used here means material that is of, relating to, or formed at the lowest possible temperature of solidification for any mixture of specified constituents. This term is used especially of an alloy whose melting point is lower than that of any other alloy composed of the same constituents in different proportions. Also, eutectic may be one mixture of a set of substances able to dissolve in one another as liquids that, of all such mixtures, liquefies at the lowest temperature. If an arbitrarily chosen liquid mixture of such substances is cooled, a temperature will be reached at which one component will begin to separate in its solid form and will continue to do so as the temperature is further decreased. As this component separates, the remaining liquid continuously becomes richer in the other component, until, eventually, the composition of the liquid reaches a value at which both substances begin to separate simultaneously as an intimate mixture of solids. This composition is the eutectic composition and the temperature at which it solidifies is the eutectic temperature. If the original liquid had the eutectic composition, no solid would separate until the eutectic temperature was reached, then both solids would separate in the same ratio as that in the liquid, while the composition of the remaining liquid, that of the deposited solid, and the temperature all remained unchanged throughout the solidification.

These properties may be beneficial for materials incorporated into engineering components used in objects which are sent into certain altitudes above Earth, such as the upper Earth atmosphere, and/or into outer space. These space environments may subject objects in them to large temperature swings due to many various factors such as direct sunlight exposure or deep shadows encountered while on orbit, varying solar fluence as a function of distance from the sun, and radiative cooling as a function of view factor to deep space.

Fiber Reinforced with Eutectic Alloys

Certain embodiments here include a material which has a fiber weave fabric surrounded by eutectic alloy material. In certain embodiments, the fiber is a carbon fiber fabric which is plated with a certain material as well. The eutectic alloy is by some method disclosed here, melted and formed around the carbon fiber fabric, adhering to and interweaving and/or intertwining with the fabric, surrounding the tows and/or fibers of the fabric and forming a shape. The result, in certain embodiments, is a shaped eutectic alloy material with an embedded carbon fiber fabric. This combination may be structurally sound and rigid after produced, and contain the characteristics described here, for space-based deployment.

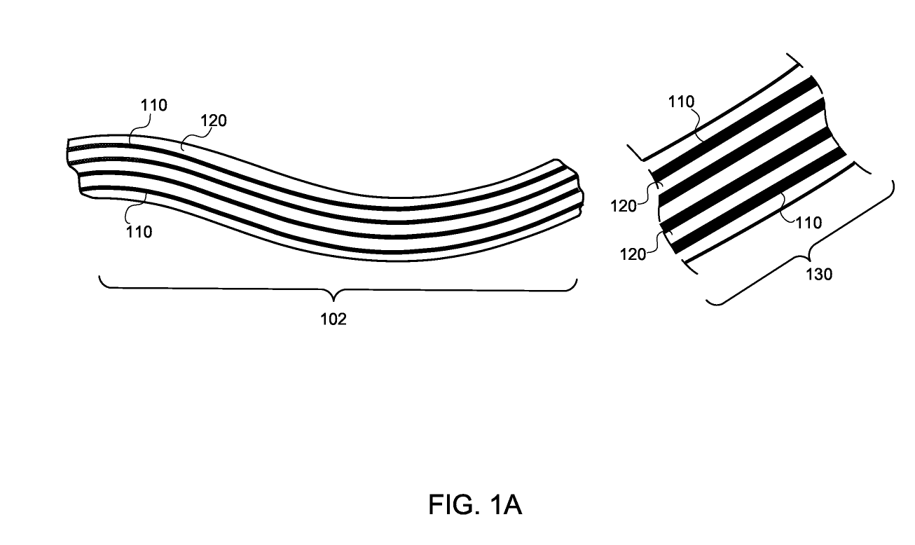

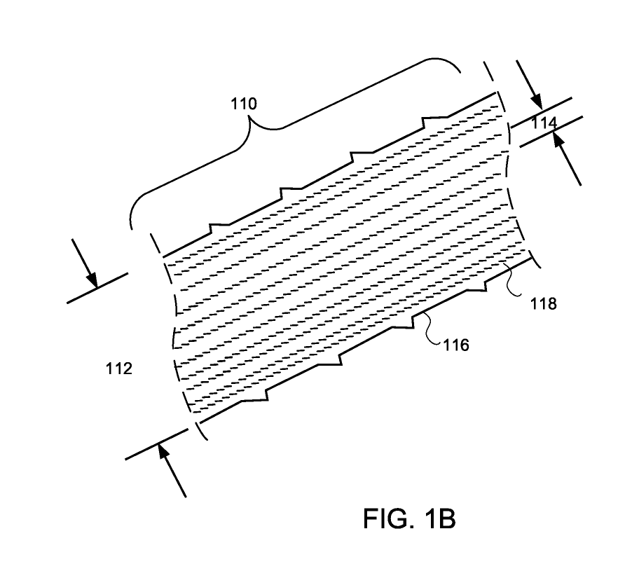

FIG. 1A shows an example embodiment of material composed of plated carbon fiber and eutectic alloy 102. Such an example embodiment may be formed via heated platen press operation, for example, or other processes. Such example embodiment material may provide moisture insensitive stability, thermal conductivity, high specific modulus, and high specific strength laminate properties, as disclosed here.

In the example embodiment shown in FIG. 1A, the material 102 is shown composed of layers of continuous and/or chopped carbon fiber tows 110 and eutectic alloy matrix 120 surrounding the fiber tows 110. FIG. 1A also shows a detail 130 of the material layers, again showing the layers of carbon fiber tows 110 and eutectic alloy layers 120. A tow may be a bundle of smaller fibers, similar to a yarn or thread. Such tows could be woven into a fabric, laid uniformly together, or any number of arrangements in order to provide a fiber endoskeleton for the final product, encased in eutectic alloy. The tow 110 widths could be any width depending on the application, but example embodiments include tow widths of 0.08-0.1 inch or 2.-2.5 nm.

The eutectic alloy matrix material may thus exhibit increased through thickness thermal conductivity relative to carbon fiber reinforced polymer matrix composite laminates. The material exhibits increased in-plane and transverse shear strength, inter-laminar shear strength, compression strength, flatwise tension, and through thickness compression modulus relative to test values for the neat polymer matrix. This can derive from the increased thermal conductivity performance of the individual metallic constituent materials making up the eutectic alloy and the metallurgical bonds formed within the matrix material. Comprised of varying combinations of, for example, one or more of, but not limited to: tin, bismuth, lead, gallium, indium, zinc, cadmium, mercury, silver, and copper, the eutectic alloy alone can be preselected for its characteristics, for example, a combination of thermal conductivity, specific strength, electrical conductivity, and reflow temperatures best meeting the system requirements for a specific component.

Referring now to the final laminate, it may consist of multiple plies of this carbon fiber encased with eutectic alloy, including, for example, flat and more complex (i.e. tubular and 3-D) geometry. The example in FIG. 1A is merely exemplary, and is not intended to be limiting. The resulting laminate properties may be a function of the selected fiber, plating, and eutectic alloy combination, among other things. As an example, for instance, a fabricated flat fiber reinforced with eutectic alloy plies, then fabricate flat and tubular laminate prototype designs from those plies.

An example of fiber reinforced prepreg fabric may be one that is able to be handled by humans, fairly flexible, and may be cut and stacked to fabricate complex geometry laminates via a heat and autoclave pressure cycle. Some other embodiment examples include, but are not limited to, integral co-cured fabrication with PMCs in a unitized component to provide additional in-plane thermal conductivity and moisture insensitivity or impermeable layer. By selecting a compatible reflow temperature to that of the cure temperature of the prepreg resin, co-curing of fiber reinforced eutectic alloy materials and conventional PMCs could improve moisture response and stability, and potentially lower labor cost for integrating heat spreaders and thermal interfaces for mounting of electronics hardware on the composite structure, minimizing risk of arcing due to static discharge buildup, a common hurdle in Earth orbit. Further, such material may act as integral heat spreaders and ground plane/electrical traces, welding pads for electrical connections, or ESD coatings, minimizing the requirements of secondary operations to achieve electrical conductivity or ground plane requirements for space-based hardware.

Referring again to FIG. 1A, it illustrates a longitudinal (top) view of one embodiment of such example material in a unidirectional tape form. Other example embodiments may include the ply forming unidirectional, two-dimensional woven fabric, veil and scrim, and three-dimensional fiber arrangement. These may be similarly arranged to the example embodiment of FIG. 1A.

In FIG. 1A, the example carbon fibers 110 are shown here, combined with ribbon preforms of eutectic alloys 120. Such combination could be through heat and/or pressure, such as processing in a heated platen press or autoclave, other various ways. In such an example, the Eutectic alloy material 120 surrounds the fiber tows 110. A tow may also be referred to as a roving or a ribbon. Eutectic alloy, if found on a roll, may also be referred to as a ribbon. A detail of the material 130, shows a more exaggerated view of the carbon fibers 110 and the eutectic alloy material 120.

FIG. 1B shows an example detail of a portion of an individual filament tow 110. The example tow 110 width may be any number of widths, including 0.08-0.10 inches (2-2.25 mm) 112. Additionally, certain example embodiments have each tow composed of individual filaments. For example, there may be 3000-12000 fiber filament tows. Other examples include tows with up to 80,0000 filaments. And certain example embodiment filament diameters may be 200-3000 micro inches (5-8 microns) 114. Other examples include other diameters, depending on the application. Each tow 110, made of filaments, could have a ragged surface, depending how the filament is constructed. In the example embodiment in FIG. 1B, the surface of the tow 116, is shown with a saw-tooth or twisted looking surface. Also shown in the example embodiment of FIG. 1B is the individual filament boundaries 118. As the tow 110 is made of separate filaments, the filament boundaries 118 shown up as individual lines 118 running through the tow 110.

Many variations of tow widths, number of filaments, and filament diameters could be included, but the examples here are merely illustrative, and not limiting.

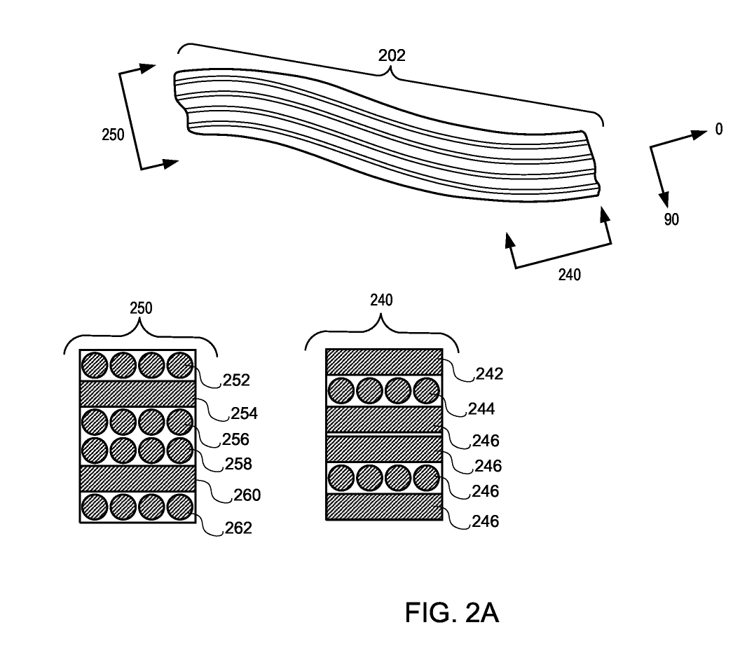

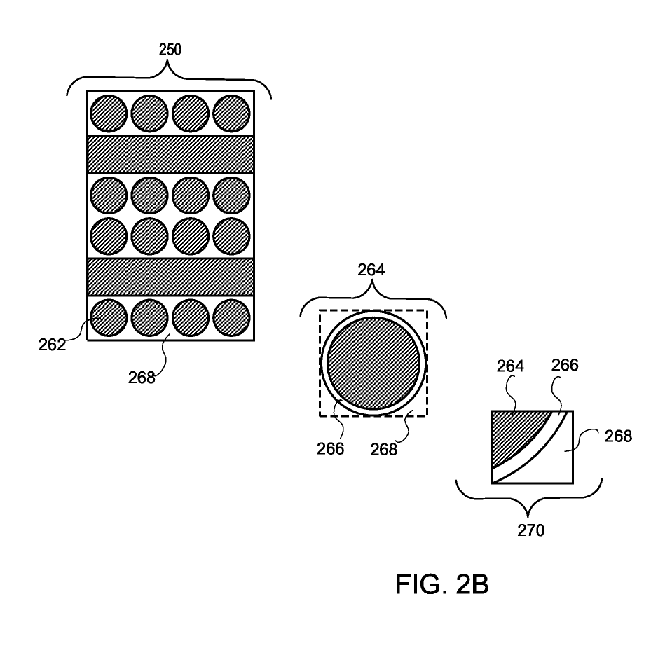

FIG. 2A illustrates an example top view of a ply or laminate 202. Certain example coordinate systems for fiber alignment may anywhere be from 0 to 90 degrees, relative to the lengthwise direction of the material. In the example embodiment, an end view 250 is shown, as well as a side view 240. Alternately, a chopped fiber approach may have randomized fiber directions.

FIG. 2A also illustrates two example cross-sectional views of the material in a laminated configuration. The first 250 corresponds to the end on view of the ply or laminate referencing the top view 202. The second 240 corresponds to the side view of the ply or laminate 202. In the example embodiment views, the carbon fibers can be seen to maintain their spacing as dictated any number of things, such as but not limited to, tow size, fiber orientation, and/or kind of weave, for example.

In the end on view example 250 there are layers 252, 254, 256, 258, 260, and 262. The circles in layers 252, 256, 258 and 262 indicate that the tows are running in and out of the page, perpendicular to those shown as elongated rectangles 254, 260 which indicate that those tows are running from left to right on the page. Thus, the layers shown alternate directions, 90 degrees relative to one another, depending on the layer. In this example embodiment, the layers are shown to alternate directions, and then repeat directions, but any kind of weave, pattern, and layering could be used.

The side view example, 240 the same tows are shown but from a 90 degree different angle, the side of the ply instead of end on like 250 illustrates. Thus, tow fiber 242 is a side view of fiber 252, and 244 is a side view of 254, etc. showing how one particular example may be arranged in layers. These patterns of layering are exemplary only, and could run in any number of directions, and be layers in any number of patters, alternating, repeating, etc. The examples shown here are illustrative only and should not be construed as limiting.

FIG. 2B illustrates an example enlargement 264 of one of the end on view layers 262 of a tow from the cross-sectional view 250. Each tow 264 is shown plated 266 with material prior to combining with the eutectic 268. A further enlargement quarter 270 shows this again in even more detail. The eutectic alloys 268 can be seen to surround and/or engulf and be adhered to the dry fiber preform fibers 264. Due to the plating of metallic fiber directly to the carbon tow, the eutectic matrix material 268 has an affinity for the plated preform 266 and “plates” on both intermediate and high modulus fiber tows 264 for example. In certain example embodiments, the eutectic alloy matrix material may be produced with no, or minimal air bubbles or entrained/entrapped air, reducing the chances for inclusion of voids in the resulting prepreg or (previously impregnated) and cured component.

### Example Selection of Materials

In certain example embodiments, the constituent materials may be conventional carbon fiber and eutectic alloy. In an embodiment for aerospace applications requiring zero moisture strain and high specific stiffness, ultra-high modulus grade fibers may be used. Such example materials may provide stiffness for the resulting composite material, and may also achieve low in-plane coefficient of thermal expansion. Resisting laminate moisture strain in high performance optical systems may simplify current instrument integration requirements for alignment and humidity control. Such an example stable, low strain material may provide structures, that can allow for reduction in and/or reallocation of moisture and temperature error budgets.

Another example includes a veil material form, which is a thin, semi-transparent mat composed of chopped carbon fibers arranged in a random manner similar to fabric. Certain examples of material selection factors include selection of materials where the carbon fibers are not selected to such a high modulus that breakage due to sensitivity of the material is rampant. Additionally, regarding selection of materials, sizing may be removed from the fiber surface by cooking off the material at high temperature. Sizing, here is a lubricant and bonding agent applied by the fiber manufacturer to aid in the handle-ability of the loose tow.

Other factors of material selection to consider include structural performance of the resulting ply material which may be increased by improving the integrity of the plated material to the fiber surface, for example, for fibers properly stripped of sizing prior to electro-plating of either the Cu or nickel strike layer.

Various laminate and lamina computer codes may be used to evaluate and select appropriate fiber and alloy combinations based on application requirements. Various combinations of fiber, plating, and eutectic alloy matrix materials, for example, may be physically and mechanically simulated via micromechanics analyses to help predict moisture and temperature dependent lamina properties and define designs for fabrication. Example embodiments include unidirectional, five harness satin fabric, and plain weave fabric material forms. These may be pre-impregnated with a combination of eutectic alloy matrices including, but not limited to: Indium Alloy #1e, comprised of indium and tin, Indium Alloy #205, comprised of indium and lead, Indium Alloy #256, comprised of mostly tin with silver and trace amounts of copper, and Indium Alloy #28, comprised of bismuth and tin.

Example embodiment selections may be made based upon the available reflow temperature they exhibit, and the enhanced specific strength those matrix materials exhibit alone without benefit of fiber reinforcement, for example. Other combinations of interest in eutectic alloy include but are not limited to, Indium Alloy #282, comprised of bismuth and tin, which exhibits an example processing temperature of approximately 280° F. Additionally, another example includes Indium Alloy #11 and 12, comprised of mostly lead with some tin and silver.

Example embodiment selection of the eutectic alloys can be seen to vary little in form, as an example drawn thickness is 0.002 inches but could be any thickness. The eutectic alloys may also exhibit varying material performances when compared to one another due to their varying chemical makeup. As an example, the pliability of the Indium Alloy #256 eutectic alloy material compared to Indium Alloy #1e is significantly higher. Yet, minute changes in material behavior may have no or minimal impact on the press cure and three wheel pinch roller prepregging methods, only on the final constituent properties of the fiber reinforced eutectic alloy prepreg component, for example.

Once selection of the materials is completed, the materials may be assembled. For example, the fiber reinforced fabric may be handled, may be fairly flexible, and may be cut and stacked to fabricate laminates via an additional pressure cycle. The “prepreg” fabric exhibits little difference from its PMC counterpart, other than it appears not to be as sensitive in terms of cure results to handling and finger oils as do PMCs. The fabrication of eutectic alloy material may be limited by the width of the fabric preform that can be fabricated, given that the prepregging step may involve stacking of subsequent, for example, 4 inch wide eutectic alloy ribbon preforms side by side to provide a custom web width of material during prepregging.

The final laminate may consist of multiple plies including, for example, flat and complex, such as tubular, or complex 3-D geometry. The resulting laminate properties may result from the selection of fiber, plating, alloy, and/or repeatability of the prepreg manufacturing process. Flat, tubular, and complex 3-D laminate prototype designs are possible, for example, along with any other design.

### Example Methods of Manufacture

Also described here are steps to both manufacture the material using a lab heated press method as well as prepreg autoclave processes tailored to fabricate either tubular or complicated 3-D component geometry. To fabricate laboratory development material, preforms for both the eutectic alloy and the intermediate modulus carbon fiber reinforcement are prepared and sized for heated platen press forming. An electric resistance or oil circulated heated platen press defines the dimensions of the flat eutectic alloy carbon reinforced prepreg that can be formed. The fiber reinforcement preform may be prepared with a dam for the eutectic material fabricated from high temperature silica or metallic tape or other dam material that can withstand both the pressure and temperature of the press reflow process. Eutectic preform may be placed on top of the fiber reinforcement preform, a protective high temperature material layer may then added, and material dependent pressure and heat is applied to the material stack sandwiched between upper and lower heated platens. After reflow is complete, the now formed “ply” of fiber reinforced eutectic alloy material may be removed from the press and cools to room temperature in a flat sheet form which can then be used to build up various laminates. Two-dimensional structures can be direct manufactured using the press process.

Tubular and complicated 3-D geometry structures require different laminate buildup techniques on specifically machined tooling beginning with the reflowed eutectic alloy ply material form. Utilizing the ply forming process described in brief form above, sufficient ply material is required to build up either tubular structures on mandrels or 3-D structures on dedicated tooling to provide a “tooled surface” against which vacuum and autoclave pressure can be applied during the cure/reflow cycle. In the case of tubular structures, the desired laminate properties yield a specific ply “schedule”—an order of plies, their orientation, and their preform type, either tape or fabric—which is wrapped around the mandrel in a specific orientation and sequence so as to meet both the thermal stability and structural margins required of the completed part. Based upon individual ply properties, the design will follow a prescribed sequence of varying orientation “flag” plies wrapped around the mold-released metallic mandrel. With each successive layer, vacuum debulking steps are employed to reduce bulk factor of the wrapped play material. Once the laminate schedule layup has been completed, a final vacuum debulking and shrink taping cycle are utilized to compact the tubular structure as much as is practicable, in order to minimize/eradicate void content and provide consolidation pressure to drive any entrapped air out of the laminate layers.

For this case, once the component has been vacuum bagged and vacuum has been applied to the mandrel, the tooling assembly is placed in an autoclave to simultaneously draw vacuum and apply pressure to the external surface of the vacuum debulked part. After sufficient time has been allowed to bring the eutectic alloy prepreg to reflow temperature and further debulk the laminate, the tubular structure is removed from the autoclave, allowed to cool, and then debagged. Due to the shrink factor of the metallic mandrel, parts typically become detached from the mandrel with little force, as the thermal shrinkage due to cooling of the metallic mandrel provides sufficient shrinkage of the mandrel to cause the thermally stable eutectic alloy tubular structure to separate from the face of the mandrel, allowing removal of the tool. The now reflowed fiber reinforced eutectic alloy tubular structure can be machined to length, interface fittings bonded to the tubular structure as necessary, or bonded directly in place to the application component in order to provide both good compressive strength and flexure properties in an inherently thermally conductive interface structure.

The 3-D geometry autoclave process follows much the same tack as that described above for the tubular structure manufacturing approach. However, for example, instead of wrapping and debulking successive eutectic alloy plies, individual plies are cut either by hand or automated blade cutting device to kit the plies that are then applied to the face of complex tooling to form the tooled surface and allow for successive vacuum debulk steps to allow optimal, void free consolidation of the fiber reinforced eutectic alloy components. Once debulk and final vacuum bagging and vacuum integrity verification steps have been performed, the component can be placed inside an autoclave where the vacuum bag port and part/tool thermocouples are connected. An autoclave cure which applies pressure at the moment the lagging thermo-couple reaches the lower bound of the reflow temperature range is applied to drive out entrapped air, consolidate the laminates of the component, and ensure good continuity of form against the tooled surface to maintain net dimensions of the finished part without the necessity for post-machining

### More Example Methods of Manufacture

Example methods of manufacturing carbon fiber with eutectic alloys in particular forms, may include: determining the stability, precision, and/or structural integrity requirements of the completed components as dictated by the environment of the assembly. Example method embodiments may use component geometry (for example, 2-D planar, tubular, or complex 3-D layup), ply material property performance parameters, and laminated plate theory to then select the appropriate eutectic alloy performance characteristics, establish the appropriate manufacturing sequence of layup, and conduct consolidation/reflow process to yield the final base geometry component. Example method embodiments may then take the various raw material forms to be precision machined to final dimensions using conventional metallic machining practices, such as those employed when machining either aluminum or nickel stock or structures. Example methods of manufacture may then take the final precision shapes to be assembled and fastened or bonded into the target telescope assembly, for example.

Example embodiment methods of manufacturing of the material may include machining, for example, and using it to fabricate structural assemblies. Machining of the material can be, for example, conducted much as a normal billet or sheet of material would be based upon the makeup of the eutectic alloy. For example, tin and lead predominant eutectic alloy formulations, relatively low feed rates and speeds may be used to machine the material cleanly. For bismuth and silver containing formulations, for example, increased feeds and speeds during machining or trimming may be possible without loss of accuracy or increase in cutter wear.

Thus, wherever flat laminate, tubular, or complex 3-D geometry stable example embodiments may be used, the fiber reinforced eutectic alloy material can be used to fabricate high specific modulus and specific strength moisture and thermally stable aerospace components for orbital and space-based applications.

Other example methods of manufacture may include integral fabrication using co-curing of eutectic alloys with matched reflow temperatures in combination with curing of Polymer Matrix Composites (PMCs), thus providing a hybrid construction of PMC and thermally conductive eutectic alloy fiber reinforcement as a thermal interface layer, heat spreader, and/or electrical interface/grounding plane for composite structures. Further example method embodiments of manufacture may include, for example, integral ground path/electrical trace incorporation in the PMC component, welding pads for electrically connecting assembly components to the structure, and as an electrostatic discharge (ESD) layer.

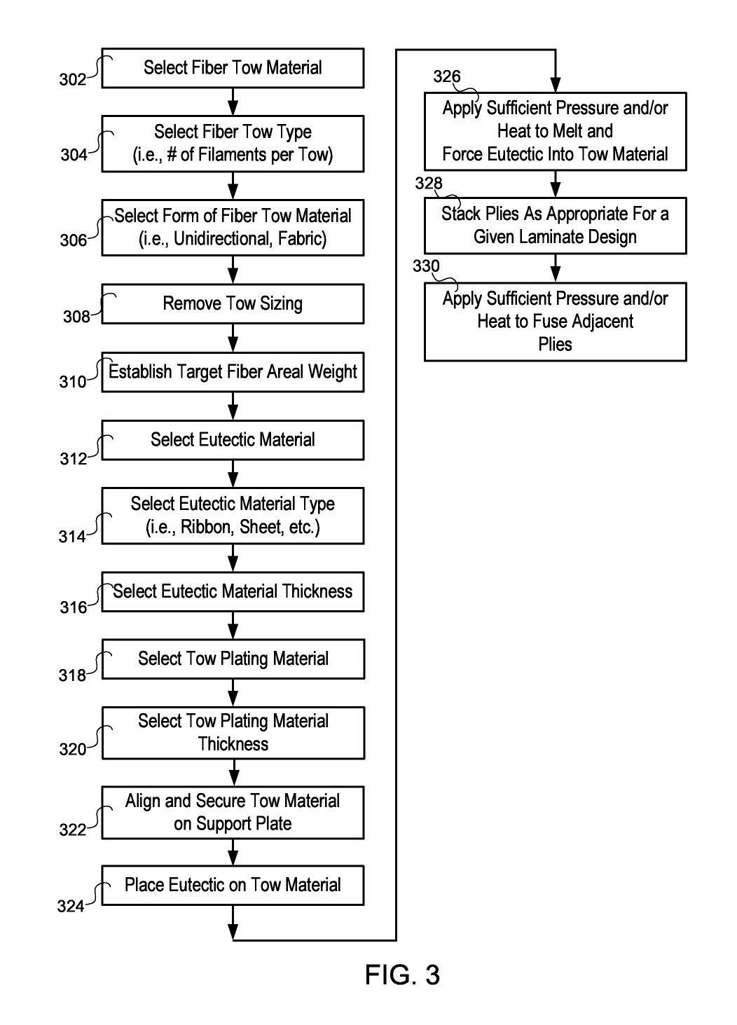

FIG. 3 illustrates an example flow diagram of a method of manufacture of the material. In this example method, the platen press manufacturing procedure is used in conjunction with carbon tow material woven into a fabric form.

One example of the method includes the procedure of laminating carbon fiber reinforced eutectic alloy plies in lieu of traditional polymer matrix composite prepreg materials. The design and fabrication method permits selection of appropriate fiber and eutectic alloy constituent materials to optimize the material's low moisture strain and thermal strain properties for a specific applications requirement(s).

As shown in FIG. 3, first, a selection of fiber tow material is made, 302. Next is a selection of fiber tow type 304, such as the number of filaments per tow. Then, a selection of form of fiber tow material is made 306. An example of this may be a unidirectional fabric. Then comes a removal of tow sizing 308. Next is an establishment of target fiber areal weight 310. Then, a selection of eutectic material 312, followed by election of the eutectic material type 314. An example of this may be ribbon, or sheet, etc. Then comes a selection of eutectic material thickness 316 followed by a selection of two plating material 318. Following this may be selection of tow plating material thickness 320 and an alignment and securement of tow material on a support plate 322. Then, the eutectic material is placed on the tow material 324. Then comes an application of sufficient pressure and heat (temperature) to force the eutectic into the tow material 326. In certain embodiment examples, a simple handheld table iron may be sufficient to uniformly apply several pounds per square inch of pressure at the eutectic temperature to produce small lamina pieces. Optional equipment approaches to produce lamina in large quantities include but are not limited to an autoclave, platen press, and a roller system. Next is to stack piles as appropriate for the given laminate design 328. Finally, apply sufficient pressure and/or heat to fuse the adjacent piles 330.

Any number of these steps could be modified and/or adapted to particular applications. Selection of the materials and thicknesses, for example could be made in different orders, depending on the circumstances. The steps of making the material, however are laid out above.

The procedure for unidirectional tow material form is similar to fabric but may require additional provisions to secure fibers, for example, via tape, or some other way, to preserve alignment and straightness. Examples could be Tin on Nickel coated fiber tows, copper on plain wave fabric tows and copper on nickel coated fiber tows. These examples are only exemplary and could be other combinations as well.

Different example methods of manufacture may include, for example, lay-up, press, and autoclave processes. The lay-up ply fabrication method locates fibers and ribbon in a flat ply configuration. Measuring an appropriate ply size for the available platen dimensions, the dry carbon fiber reinforcement fabric is cut to size and its perimeter taped with material to provide edge dams to contain the eutectic alloy during reflow. With the dams in place, the fabric ply is placed on a release ply such as Armalon cloth to both, for example, among other things, control flow of the material through the dry fabric preform and prevent metallic bonding to the platen during reflow of the eutectic alloy. The eutectic alloy preform is then cut to match the dimensions of the dam and laid on top of the dry fabric preform. A second layer of release ply such as Armalon cloth can be placed on top of the stack. The platen press may be pre-heated to a temperature of, for example, approximately, +10°/+20° C. over the liquidus temperature of the selected eutectic alloy, and the stack can be loaded into the platens and immediately closed to apply approximately, for example, 500-1500 psi pressure between the platens. Depending upon the choice of eutectic alloy, hold times can range from approximately, for example, about 10-25 minutes under pressure. Once the hold time at temperature has been met, the platens are opened and the stack is removed to cool.

The stack can be then separated, for example, from the release plies by peeling them up from the surface of the cooled plies. The tape dams can either be left in place if the material is to be used in any layup sequence requiring non-planar geometry, as the dams tend to resist bending and forming of the plies. If the material is to be used in a 2-D flat laminate schedule, the dam material should be removed to allow even pressure to be distributed across the laminate stack. Then the plies are cut with additional margin to the appropriate shapes to satisfy the 2-D flat laminate dimensions. Conventional dams, for example, typically used with PMC fabrication are used to prevent too much flow of the eutectic alloy at the margins during the reflow process. The entire stack can then be vacuum bagged using both, for example, a release ply and breather layer suited for the top temperature of the reflow process. After a vacuum check has been performed on the bagged assembly, the stack is placed in a vacuum oven or autoclave and the temperature is ramped at a rate of, for example, 15°-20° C. per minute to the hold temperature, and held at temperature, depending upon the selected eutectic alloy material, for a similar example time of 10-25 minutes at a temperature from about, for example, +10°/+20° C. above the liquidus temperature for the selected eutectic alloy material. The stack can then be ramped down at a similar example temperature rate of 15°-20° C. per minute to about or approximately, for example, 70° C. and removed from the vacuum oven or autoclave and is ready for trim or final machine.

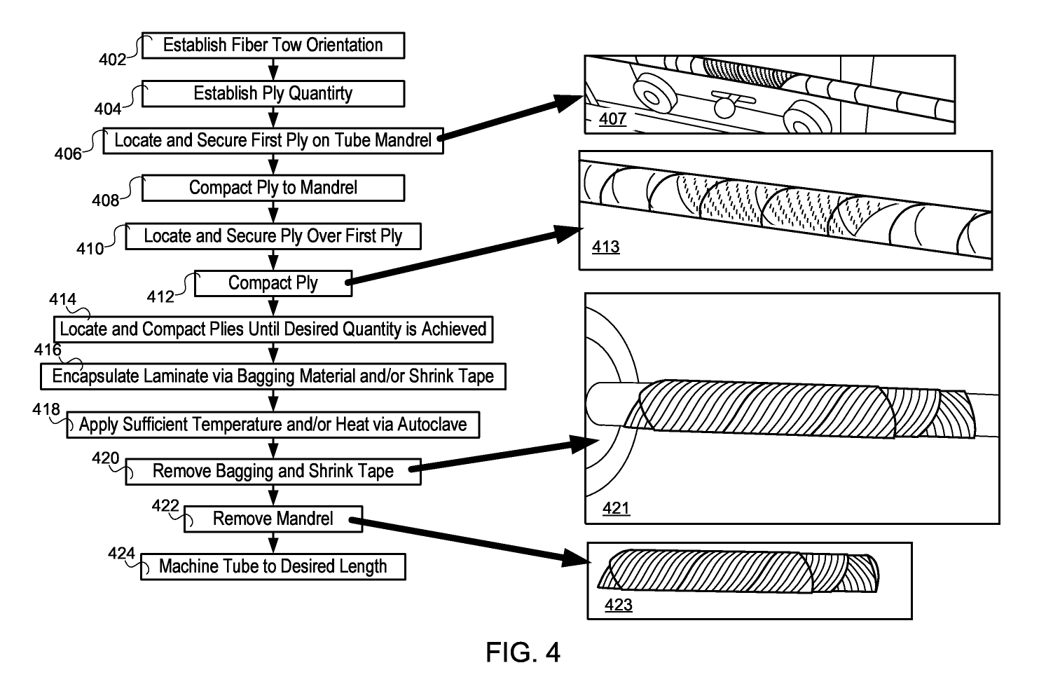

FIG. 4 illustrates example embodiments of methods of manufacturing specific structures. For example, tubular structures, where a similar layup approach and manufacturing procedure can be utilized, but a cylindrical or tapered mandrel with a anodized or mold released surface is prepared prior to layup.

In FIG. 4, the example method of manufacture includes establishing a fiber tow orientation 402. Next, establishing a ply quantity 404, followed by locating and securing a first ply on a tube mandrel, 406. This step is also shown, for example, as an example embodiment in the call out diagram 407. Plies can be wrapped per the ply schedule called for the design in this step. Next, compacting the ply to the mandrel 408 and then locating and securing a second ply over the first ply 410. Then, compacting the ply 412, where again, plies can be wrapped per the ply schedule called for the design in this step. This step is also shown, for example, as an example embodiment in the call out diagram 413. Here, certain embodiments include no overlaps at the perimeter of the adjacent plies, and that a butt splice is achieved that provides no more than, for example, 0.05 inch gap, for example. A release ply may be added to the exterior surface of the laminate at completion, but instead of vacuum bagging, shrink tape, for example among other things, can be used to quickly apply compression to the exterior of the layup. The next steps includes locating and compacting plies until the desired quantity is achieved 414. Next, encapsulating laminate via bagging material and/or shrink tape 416. Then, applying sufficient heat and/or pressure via an autoclave 418. During the cure process, shrinking of the shrink tape may apply compression to the outer surface, achieving the same debulking that a vacuum bag provides during cure. Certain embodiments use successive layers of shrink tape, taking care to reverse wrap direction in order to ensure no gaps in the shrink tape will allow the escape of flowing eutectic alloy material during reflow. Similar ramp rates, hold time duration, for example dwell, and ramp down apply to the tubular structure reflow process. Upon cool down and removal from the oven, in a shrink tape embodiment, or autoclave for bagging embodiment, the mandrel may pull away from the internal diameter of the tube as the mandrel cools and likely separate on its own. If the mandrel does not release, a slide hammer may be used to break any remaining bond on the interior of the tube, resulting in the mandrel being slid out of the part no worse for wear, ready to be processed and prepared for the next cure. Then, removing the bagging and/or shrink tape 420. This step is also shown, for example, as an example embodiment in the call out diagram 421. This is followed by removing the mandrel 422. This step is also shown, for example, as an example embodiment in the call out diagram 423. And machining the tube to the desired length 424 to finalize.

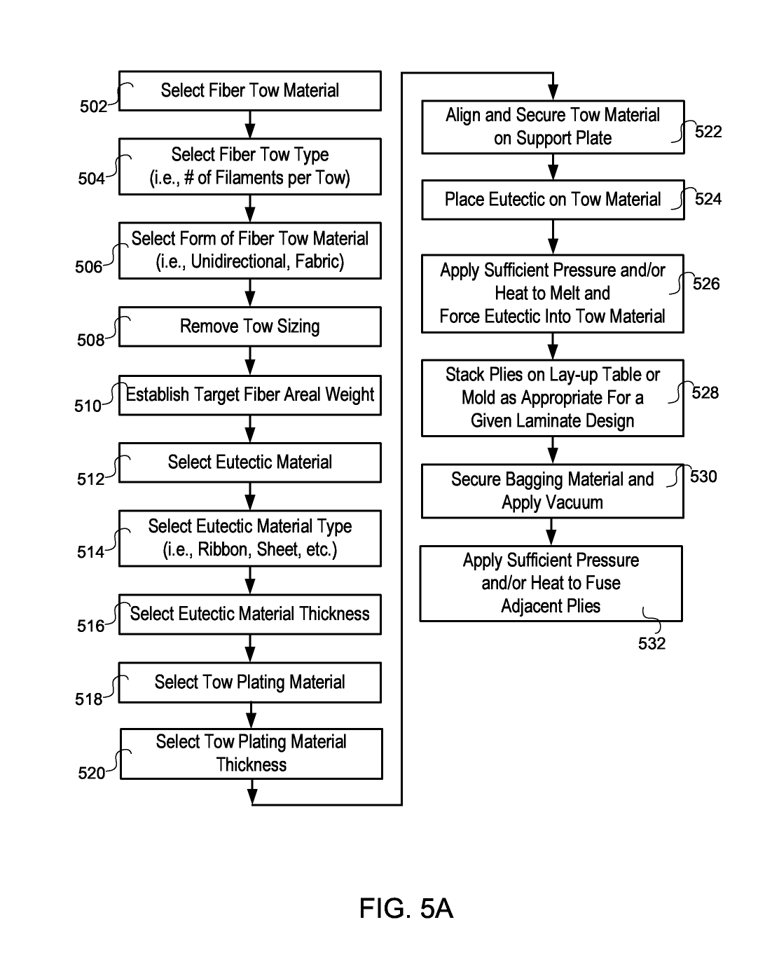

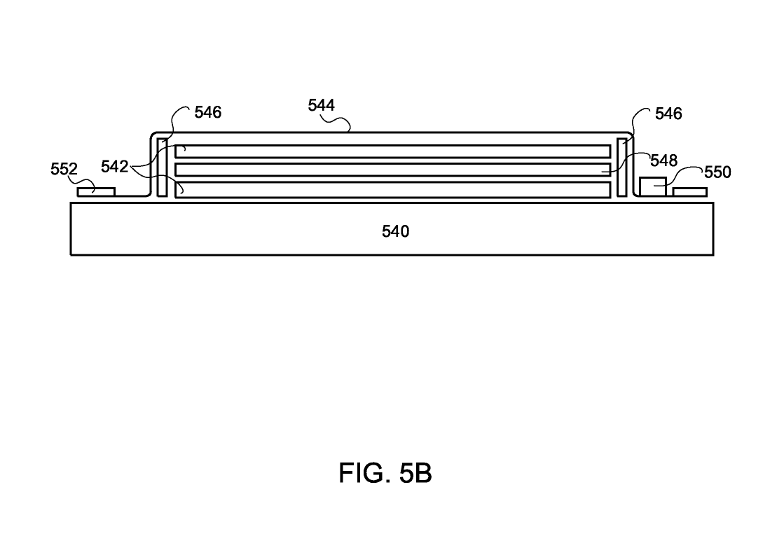

FIG. 5A is an example flow chart illustrating example methods of manufacture of other shapes including complex 3-D geometry layup embodiments. In certain examples, autoclave pressure for example, may be used to ensure consolidation of the laminates, no or minimal air entrapment between plies, and no or minimal bridging over curved features in the tool Layup.

Thus, an example method of making such an embodiment, may include first selecting the fiber tow material, 502. Next, selection of fiber tow type 504. This may include selection of the number of filaments per tow, for example. Next, selection of form of fiber tow material 506. This may include unidirectional, fabric, etc. for example. Then, removing tow sizing, 506 as explained in this disclosure. After that, establishing target fiber areal weight 510. Then, selection of eutectic material 512. Next, selection of eutectic material type 514. This may be, for example, ribbon, sheet, etc. Then, selection of eutectic material thickness 516. Next, may be selection of tow plating material 518. Then, selection of tow plating material thickness 520. After that, alignment and securing the tow material on a support plate, 522. Then placing eutectic on tow material, 524. Next, applying sufficient pressure and/or heat to melt and force eutectic into the tow material 526. Then, stacking plies on lay-up table and/or mold as appropriate depending on the desired laminate designs 528. Next is securing a bagging material and apply a vacuum 530. Finally, applying sufficient pressure and/or heat to fuse adjacent plies 532.

FIG. 5B shows an example embodiment of a flat lay-up table with bagging under vacuum arrangement. For example, in this example embodiment, the lay-up table 540 may be used with the method described above in FIG. 5A. Thus, the lay-up table 540 includes at least two armalons 542, between which the example carbon eutectic plies 548 are placed. The vacuum bag, 544 which is configured to have sealed edges at the lay-up table. This arrangement is found, in this example, between the edge dams 546 on either side. The vacuum port 550 may be configured to allow for the vacuum attachment to remove air, and the seal 552, may be configured to seal the bag.

In certain embodiments, these steps may be performed in largely the same fashion as with flat laminates, as explained in FIG. 4. For example, except that some darting and filling of the prepreg plies, such as cutting relief slits or filling in material where a corner may have to be opened up to allow for conformal lay down of the ply, may be required to ensure a consistent thickness, conformal part during successive vacuum debulk steps during layup. Though completing a vacuum debulk of plies every certain number of plies, for example 3-4 plies, may be acceptable for the 2-D flat laminate, in contrast, for complex 3-D geometry embodiments, vacuum debulks may be used approximately every 1-2 plies, for example, to ensure adequate compaction is achieved and bridging of the plies is avoided. The remainder of the bagging and prep procedures may be approximately the same.

In certain embodiments, however, during autoclave cure as an example, 10-15 psig pressure could be added from the beginning of the temperature ramp to a point approximately 5° C. below, for example, the solidus temperature of the selected eutectic alloy. An example may be a ramp of about 15-20° C. per minute. This may help with consolidation and compaction in radii among other things. By applying approximately 35-40 psig pressure, for example, inside the autoclave at this point, softening of the material approaching the solidus temperature may allow further compaction and consolidation of the plies to help with contact with the tool and an acceptable part once demolded. The remainder of the cure may remain the same as described above, for example, unless thermocouples monitoring the part and tool temperature note any increase in temperature during the hold, at which point the cure may be adjusted to ensure the time/temp requirement for the reflow process is met.

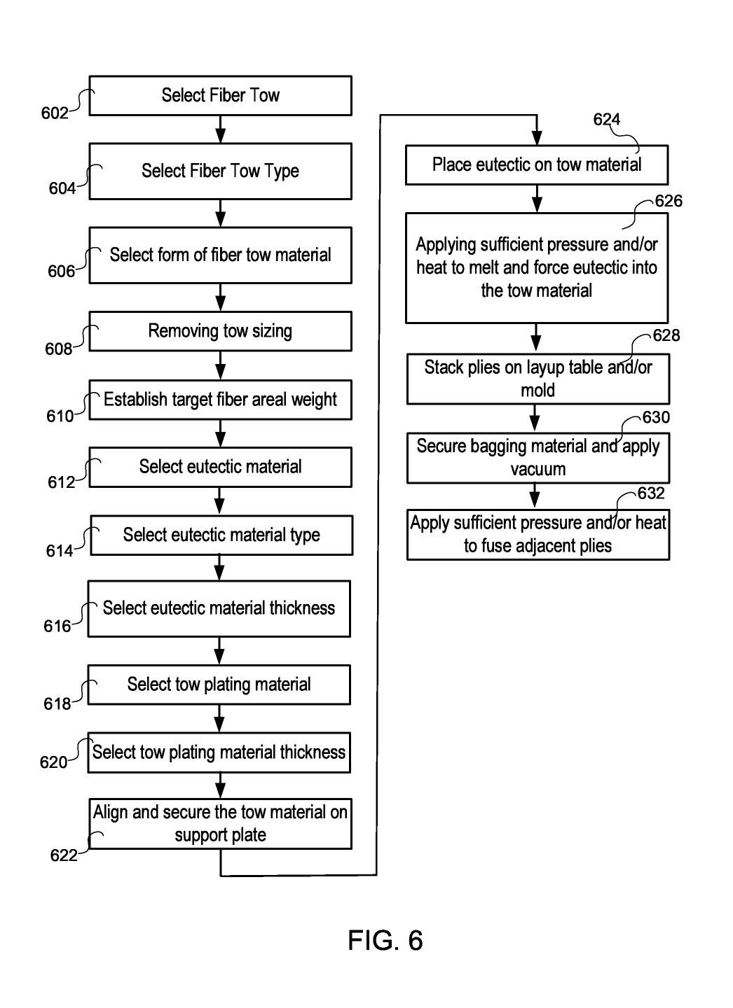

FIG. 6 includes an example flow chart of a method of manufacture of certain embodiments including fabrication methods using a hot melt resin filming process which employs a series of heated and cooled nip rollers, such as those of fabrication methods of conventional composite materials. Such example automated production may be adopted to simplify the pre-plying process and rapidly fabricate long rolls of carbon tow reinforced eutectic ply material. The nature of the indium or bismuth containing solders at room temperature may be such that they are not particularly robust and could be subjected to damage or tearing during production without a carrier supporting the material. Similar to the poly-backed film resin currently used in hot melt resin film process, a carrier may be required to support the roll of eutectic ribbon solder material. This pressure roller process could melt the alloy and compresses the fiber and liquid alloy to form a fiber reinforced tape, that is, ply.

In FIG. 6, for example, the first step may include first selecting the fiber tow material, 602. Next, selection of fiber tow type 604. This may include selection of the number of filaments per tow, for example. Next, selection of form of fiber tow material 606. This may include unidirectional, fabric, etc. for example. Then, removing tow sizing, 608 as explained in this disclosure. After that, establishing target fiber areal weight 610. Then, selection of eutectic material 612. Next, selection of eutectic material type 614. This may be, for example, ribbon, sheet, etc. Then, selection of eutectic material thickness 616. Next, may be selection of tow plating material 618. Then, selection of tow plating material thickness 620. After that, alignment and securing the tow material on a support plate, 622. Then placing eutectic on tow material, 624. Next, applying sufficient pressure and/or heat to melt and force eutectic into the tow material 626. Then, stacking plies on lay-up table and/or mold as appropriate depending on the desired laminate designs 628. Next is securing a bagging material and apply a vacuum 630. Finally, applying sufficient pressure and/or heat to fuse adjacent plies 632.

### Example Embodiments

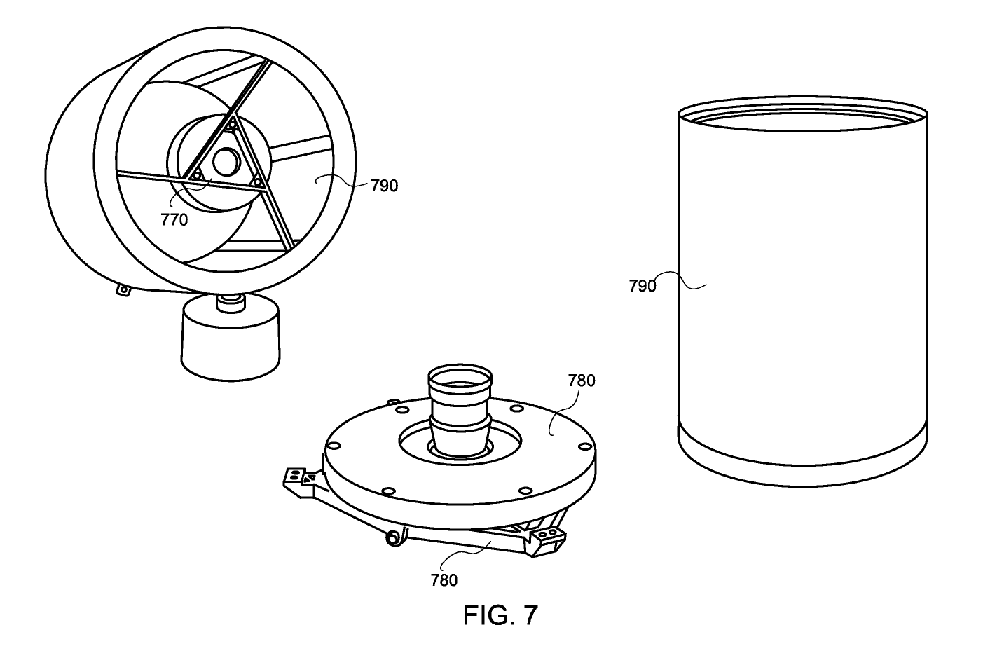

FIG. 7 illustrates example embodiments of the material used in example structures, such as in tubular and planar structures. The material may be used, for example, in infrared and visible wavelength space telescopes to provide high specific stiffness and strength, stable, metering structures such as optical benches or primary mirror bezels 780, light baffles 790, and secondary mirror support structures 770. This may help maintain stability of the telescope support structure and the various optical components in the optical train, minimizing pointing tolerance budget use in favor of higher system accuracy. Thus, for example, structures that exhibit zero or near zero moisture strain, such as those described here, may provide remote sensor system engineers opportunity to simplify or improve primary to secondary mirror alignment and simplify thermal control, integration, and test approaches.

### Example Thermal Characteristics

Thermal characteristics of the example embodiment materials here may make it useful in certain space related deployments because of its stability, among other things. To help illustrate, in an example where the heat transfer area A is adjacent to a device case, which in turn is adjacent to an interface k with thickness L, which in turn is adjacent to a heat sink.

Here, the rate of conductive heat transfer, Q, across the interface is given by:

$$Q = \frac{kA ( Tc - Ts )}{L}$$

Where: k is the thermal conductivity of the interface;
A is the heat transfer area;
L is the interface thickness; and
Tc and Ts are the device case and heat sink temperatures.

The thermal resistance of a joint, Rc-s, is given by,

$$RC - s = \frac{( Tc - Ts )}{Q}$$

And on rearrangement,

$$Rc - s = \frac{L}{kA}$$

Thus, the thermal resistance of the joint is directly proportional to the joint thickness and inversely proportional to the thermal conductivity of the medium making up the joint and to the size of the heat transfer area. Thermal resistance is minimized by making the joint as thin as possible, increasing joint thermal conductivity by eliminating interstitial air and having both surfaces in immediate contact.

### CONCLUSION

The foregoing description, for purpose of explanation, has been described with reference to specific examples. However, the illustrative discussions above are not intended to be exhaustive or to limit the invention to the precise forms disclosed. Many modifications and variations are possible in view of the above teachings. This includes practicing the examples and combinations of the subject matter described above. The examples were chosen and described in order to best explain the principles of the invention and its practical applications, to thereby enable others skilled in the art to best utilize the inventions with various modifications as are suited to the particular use contemplated.

What is claimed is:

1. A ply composition, comprising:
a piece of fabric,
wherein the fabric includes a plurality of plated tows; and eutectic alloy,
wherein the plated tows are intertwined with the eutectic alloy.

2. The composition of matter of claim 1 wherein the fabric integrated with a eutectic alloy is shaped as at least one of, a tube, a sheet and a ribbon.

3. The composition of matter of claim 1 wherein the tows are comprised of a plurality of carbon filaments.

4. The composition of matter of claim 1 wherein the eutectic alloy is at least one of, Indium Alloy #1e including indium and tin, Indium Alloy #205 including indium and lead, Indium Alloy #256 including tin, silver, and copper, Indium Alloy #28 including bismuth and tin, Indium Alloy #282 including bismuth and tin, Indium Alloy #11 including lead, tin and silver, and Indium Alloy #12, including lead, tin and silver.

5. The composition of matter of claim 1 wherein the plating is at least one of, copper and nickel.

6. The composition of matter of claim 1 wherein the fabric includes at least one of, woven tows, unidirectional tows and chopped fiber tows.

7. The composition of claim 3 wherein the plurality of carbon filaments are between 5 to 8 microns in diameter.

8. The composition of matter of claim 1 wherein the tow is between 2 to 2.5 millimeters in diameter.

9. A method of manufacturing a laminate material, comprising:
removing tow sizing on a piece of woven carbon fiber tows;
plating the woven carbon fiber tows;
placing a piece of eutectic alloy on the plated piece of woven carbon fiber tows;
applying at least one of pressure and/or heat to the piece of eutectic alloy and plated piece of woven carbon fiber tows, thereby melting the eutectic alloy to create a ply.

10. The method of claim 9 further comprising,
stacking at least two plies;
applying pressure and heat to the at least two plies, thereby fusing the at least two plies.

11. The method of claim 9 wherein the applying heat includes a temperature ramp of 15-20° C. per minute.

12. The method of claim 9 wherein the carbon fiber tows include a plurality of carbon filaments.

13. The method of claim 9 wherein the plating is at least one of, copper and nickel.

14. The method of claim 9 wherein the eutectic alloy is at least one of, Indium Alloy #1e including indium and tin, Indium Alloy #205 including indium and lead, Indium Alloy #256 including tin, silver, and copper, Indium Alloy #28 including bismuth and tin, Indium Alloy #282 including bismuth and tin, Indium Alloy #11 including lead, tin and silver, and Indium Alloy #12, including lead, tin and silver.

15. The method of claim 9 wherein the sizing is a lubricant and bonding agent.

16. The method of claim 9 wherein the tows are comprised of a plurality of carbon filaments between 5 to 8 microns in diameter.

17. The method of claim 9 wherein the tow is between 2 to 2.5 millimeters in diameter.

18. The method of claim 9 wherein the applying pressure includes 10-15 psig.

19. A eutectic alloy embedded with a carbon fiber prepared by a process comprising,
selecting a fiber tow material,
selecting a type for the fiber tow material;
selecting a form for the fiber tow material;
removing a sizing from the fiber tow material;
establishing a target fiber areal weight for the fiber tow material;
selecting a eutectic material;
selecting a shape type for the eutectic material;
selecting a material thickness for the eutectic material;
selecting a tow plating material;
selecting a thickness for the tow plating material;
aligning and securing the tow material on a support plate;
placing the eutectic material on the fiber tow material; and
applying at least one of, pressure and heat, to the eutectic material and fiber tow material, thereby melting the eutectic material and forcing the eutectic material into spaces around the fiber tow material to form a ply.

20. The eutectic alloy embedded with a carbon fiber of claim 19 prepared by a process further comprising,
stacking at least two plies on at least one of a lay-up table and a mold;
securing a bagging material to the plies;
applying a vacuum to the bagged plies;
applying at least one of pressure and heat to the bagged plies, thereby fusing the at least two plies.
